(19) United States
(12) Patent Application Publication
(10) Pub. No.: US 2007/0006778 A1
(43) Pub. Date: Jan. 11, 2007

(54) Mixture of raw materials for the production of a cement clinker, a cement clinker and a cement

(76) Inventor: Alexander Kehrmann, Xanten (DE)

Correspondence Address: MONAHAN & MOSES, LLC, 13-B W. WASHINGTON ST., GREENVILLE, SC, 29601, US

(21) Appl. No.: 11/481,651

(22) Filed: Jul. 6, 2006

(30) Foreign Application Priority Data
Jul. 8, 2005 (EP) 05 014 896.4

(51) Int. Cl. C04B 28/08; C04B 18/18

(52) U.S. Cl. 106/697; 106/789

(57) ABSTRACT

A main component of cement is cement clinker, which is produced from a mixture of raw materials containing calcium oxide, silicon dioxide, aluminium oxide and iron oxide by means of mixing, grinding and burning. According to the invention, the mixture of raw materials consists of a calcareous component and converter slag, the converter slag being added in a proportion of up to 30% by weight. Natural resources of raw materials can hereby be preserved and the carbon dioxide output during burning of the cement clinker can be reduced.

The invention relates to a mixture of raw materials for the production of a cement clinker, a cement clinker, and a cement.

Cement is a finely ground, hydraulic binder that hardens upon addition of water. Cement is primarily used for producing concrete mortar, concrete blocks or precast parts. Cement essentially consists of compounds of calcium oxide with silicon dioxide, aluminium oxide and iron oxide, which were formed by sintering.

Main components of cement are cement clinker and possibly slag sand or trass. A minor component is, inter alia, the calcium sulphate which is added in the form of gypsum stone or anhydride to regulate hardening.

Cement clinker is produced from a mixture of raw materials primarily containing calcium oxide CaO, silicon dioxide SiO₂, aluminium oxide Al₂O₃ and iron oxide Fe₂O₃ in specific proportions. When this mixture is heated to temperatures of up to approximately 1450° C., new compounds form owing to sintering, i.e. the so-called clinker phases.

In addition to limestone marl, limestone, clay and sand are also used as starting materials for the production of cement clinker. These starting materials are generally obtained as natural raw materials by means of mining in quarries. The starting materials are rarely found in the desired composition in just one raw material. A mixture of a lime-rich component (calcareous component) with a component that is more deficient in lime but contains more silicic acid, alumina and iron oxide (clay component) therefore usually has to be produced.

When producing cement clinker, carbon dioxide CO₂ is released as a result of the conversion of calcium carbonate CaCO₃ into calcium oxide CaO during the burning process, which, as is well known, is accompanied by harmful effects on the environment. Owing to the raw material limestone, this emission is unavoidable as a result of the process and reaches a volume of approximately 21 million tonnes per year in Germany alone.

A disadvantage of the production of cement is thus that large amounts of naturally occurring raw materials are consumed and that a considerable amount of CO₂ is released as a result of the production process.

In EP 0 572 076 A2, steel slag in powder form is added to a mixture of raw materials for a Portland cement in a proportion of up to 25% of the blast-furnace slag in the Portland cement. The particle size of the steel slag is approximately 0.09 mm.

Known from RU 2 207 994 C1 is a mixture of raw materials for the production of a Portland cement clinker containing carbonate, blast-furnace slag, aluminium silicate and steel slag, the steel slag being added in a proportion of 5% to 8%.

Based on the prior art, the object forming the basis for the invention is to provide a mixture of raw materials for a cement clinker, a cement clinker and a cement, the production of which conserve natural resources of raw materials, while at the same time reducing carbon dioxide emissions.

According to patent claim 1, the solution to the part of the object relating to the mixture of raw materials is that the mixture of raw materials comprises a calcareous component and converter slag.

Converter slag, in particular LD converter slag, is obtained as a waste product during steel production. Converter slag contains all the important components for the production of cement, i.e. calcium oxide CaO, silicon dioxide SiO₂, aluminium oxide Al₂O₃ and iron oxide Fe₂O₃.

The crux of the invention is the measure of replacing part of the natural raw materials with converter slag. The natural occurrences of raw materials are thereby preserved. It is furthermore advantageous that owing to the thermal processes in the converter, the carbon dioxide present in the limestone has already been burnt so that the calcium part is present as calcium oxide in the converter slag. The carbon dioxide output during burning of the cement clinker is therefore clearly reduced since considerably less calcium carbonate CaCO₃ has to be converted to calcium oxide CaO during the burning process, which thereby releases CO₂.

Converter slag is advantageously added to the mixture of raw materials in a proportion of up to 30% by weight (claim 2). In practice, a proportion of converter slag in the mixture of raw materials of 5% by weight to 10% by weight is regarded as particularly advantageous, as is provided by claim 3.

In one preferred embodiment, the mixture of raw materials consists of calcareous component and converter slag.

In another preferred embodiment, the mixture of raw materials may contain other components, besides the calcareous component and converter slag, such as iron ore, bauxite, or sand. The mixture may also contain other waste products, such as those from the steel and aluminum industries (e.g., steel slag) or fly ash. In these embodiments, the converter slag is present in an amount of up to 15% by weight, the calcareous component is present in an amount of up to 70% by weight, the remainder being one or more of the other components mentioned above.

Claim 4 is directed at a cement clinker produced from the mixture of raw materials according to the invention.

Claim 5 is directed at a cement produced from the cement clinker. Such a cement is both ecologically and economically advantageous.

The converter slag to be added to the mixture of raw materials, the cement clinker and the cement is advantageously broken down to a grain size of less than 15 mm.

2.-5. (canceled)

6. The mixture of raw materials according to claim 1, wherein the mixture comprises up to 30% by weight of the converter slag.

7. The mixture of raw materials according to claim 1, wherein the mixture comprises 5% to 10% by weight of the converter slag.

8. The mixture of raw materials according to claim 1, wherein the mixture comprises up to 15% by weight of converter slag, up to 70% by weight of a calcareous component and the balance of the mixture consists essentially of products selected from the group consisting of iron ore, bauxite, sand, and waste products from steel and aluminum production.

9. A cement clinker made by the process of sintering a raw material mixture comprising a calcareous component and converter slag.

10. The cement clinker of claim 9, wherein the mixture comprises up to 30% by weight of the converter slag.

11. The cement clinker of claim 9, wherein the mixture comprises 5% to 10% by weight of the converter slag.

12. The cement clinker of claim 9, wherein the mixture comprises up to 15% by weight of converter slag, up to 70% by weight of a calcareous component and the balance of the mixture consists essentially of products selected from the group consisting of iron ore, bauxite, sand, and waste products from steel and aluminum production.

13. A cement composition comprising the cement clinker of claim 9.

14. The cement composition of claim 13, wherein the raw material mixture used to make the cement clinker comprises up to 30% by weight of the converter slag.

15. The cement composition of claim 13, wherein the raw material mixture used to make the cement clinker comprises 5% to 10% by weight of the converter slag.

16. The cement composition of claim 13, wherein the raw material mixture used to make the cement clinker comprises up to 15% by weight of converter slag, up to 70% by weight of a calcareous component and the balance of the mixture consists essentially of products selected from the group consisting of iron ore, bauxite, sand, and waste products from steel and aluminum production.

17. The mixture of claim 1, wherein the converter slag is an LD converter slag.

18. The mixture of claim 6, wherein the converter slag is an LD converter slag.

19. The mixture of claim 7, wherein the converter slag is an LD converter slag.

20. The mixture of claim 8, wherein the converter slag is an LD converter slag.
